(19) United States
(12) Patent Application Publication
(10) Pub. No.: US 2018/0099214 A1
(43) Pub. Date: Apr. 12, 2018

(54) NUMERICAL SEQUENCE BOARD GAME

(71) Applicant: Takeshi Yamamoto, Richmond, CA (US)

(72) Inventor: Takeshi Yamamoto, Richmond, CA (US)

(21) Appl. No.: 15/289,963

(22) Filed: Oct. 11, 2016

(51) Int. Cl. A63F 3/04; A63F 3/00; G09B 19/02

(52) U.S. Cl. CPC A63F 3/0415; A63F 3/00097; G09B 19/02; A63F 3/0023; A63F 3/00697; A63F 2003/00747; A63F 2003/00195; A63F 2003/00179; A63F 3/00176; A63F 2003/00189; A63F 2003/0418

(57) ABSTRACT

A numerical sequence board game. The numerical sequence board game includes a gridded board and corresponding playing pieces. The hexagonal-shaped playing pieces may be placed on corresponding hexagonal grids on the gridded board during game play. Each playing piece may include numerical indicia that can be used to form numerical sequences with other playing pieces, wherein the numerical sequences may be formed in one or more directions on the gridded board.

### BACKGROUND OF THE DISCLOSURE

This disclosure relates generally to board games and methods and, more specifically to board games and methods for creating numerical sequences.

Board games provide great entertainment and educational value for players of all ages. Board games such as SCRABBLE™, MONOPOLY™ etc. are available to adults and children alike. Such board games often involve strategy and can be very competitive. Indeed, national and international tournaments have developed around the game of scrabble, for example. Often, however, such existing games provide entertainment and educational value typically around the use of letters to form words and/or sentences.

It is within the aforementioned context that a need for the present disclosure has arisen. Thus, there is a need to address one or more of the disadvantages of conventional systems and methods, and the present disclosure meets this need.

### BRIEF SUMMARY OF THE DISCLOSURE

Various aspects of a numerical sequence board game can be found in exemplary embodiments of the present disclosure.

In one embodiment, the numerical sequence board game includes a gridded board with a plurality of grids. Each of the grids is hexagonal-shaped. The board game may also include tiles or playing pieces that are place-able on the grids. Each one of the playing pieces has a hexagonal shape that corresponds to that of a grid.

In one embodiment, the playing pieces include numerical indicia on a face of each playing piece. During game play, the playing pieces may be placed on the grids adjacent to one another to form a numerical sequence of numbers. The numerical sequence of numbers is based on numerical indicia on the face of each playing piece. The numerical sequence of numbers may be formed in one or more directions. For each sequence, a numerical difference that is determined by the user, exists between the playing pieces that form a sequence.

In one embodiment, the numerical indicia may be a single digit that is displayed on the face of the playing piece. In a further embodiment, the numerical indicia is a double digit, wherein a first of the double digit is displayed on a face of the playing piece while a second digit of the double digit is not displayed. As an example, for such a double digit, the “unit position” may be displayed while the “ten position” is not displayed on the face of the playing piece. In another embodiment, a total point value for a numerical sequence is the total point value obtained by adding the point value of each playing piece in the numerical sequence.

A further understanding of the nature and advantages of the present disclosure herein may be realized by reference to the remaining portions of the specification and the attached drawings. Further features and advantages of the present disclosure, as well as the structure and operation of various embodiments of the present disclosure, are described in detail below with respect to the accompanying drawings. In the drawings, the same reference numbers indicate identical or functionally similar elements.

### BRIEF DESCRIPTION OF THE DRAWINGS

FIG. 1 illustrates a numerical board game according to an exemplary embodiment of the disclosure herein.

FIG. 2 illustrates a game board of the numerical board game of FIG. 1 showing the directions in which playing pieces may be placed.

FIG. 3 illustrates the game board of FIG. 1 showing slanted and upright positions during the course of the game.

FIG. 4 illustrates play of the numerical board game of FIG. 1 according to the exemplary embodiment of the present disclosure.

FIG. 5 illustrates the game board of FIG. 4 showing a numerical sequence formed by a first player during a first round of play.

FIG. 6 illustrates a game board showing playing pieces that are played by a second player following the first round of play by the first player in FIG. 5.

FIG. 7 illustrates a game board according to an exemplary embodiment of the present disclosure.

FIG. 8 illustrates a game board according to an exemplary embodiment of the present disclosure.

### DETAILED DESCRIPTION OF THE DISCLOSURE

Reference will now be made in detail to the embodiments of the disclosure, examples of which are illustrated in the accompanying drawings. While the disclosure will be described in conjunction with the one embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth to provide a thorough understanding of the present disclosure. However, it will be obvious to one of ordinary skill in the art that the present disclosure may be practiced without these specific details. In other instances, well-known methods, procedures, components, and circuits have not been described in detail as to not unnecessarily obscure aspects of the present disclosure.

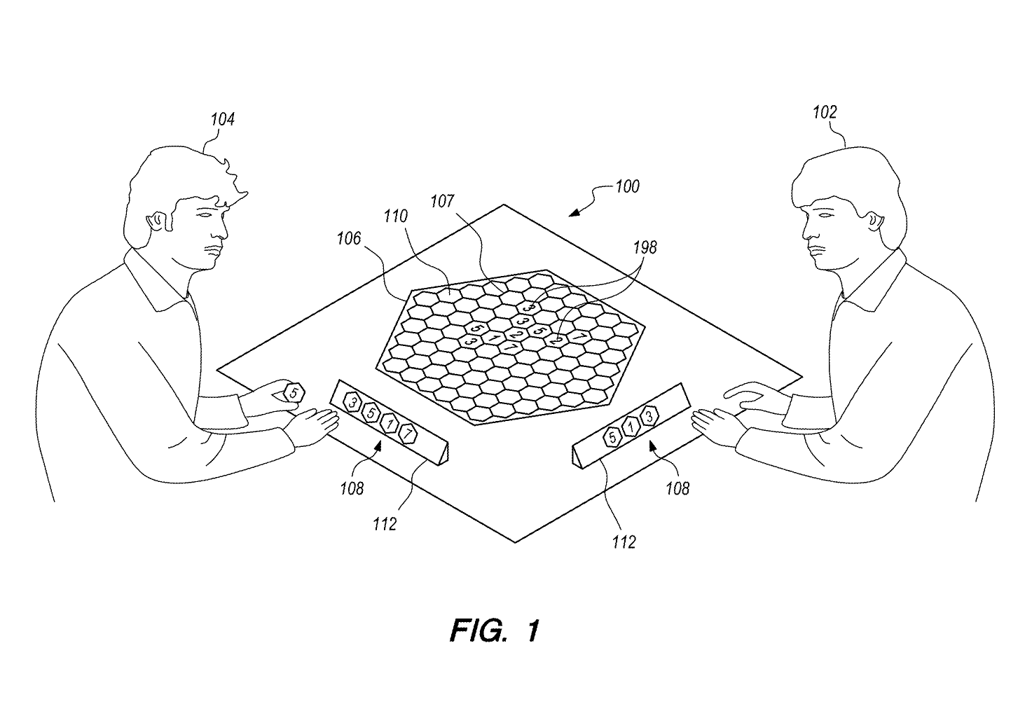

FIG. 1 illustrates numerical board game 100 according to an exemplary embodiment of the disclosure of herein.

In FIG. 1, a plurality of players 102, 104 may utilize numerical board game 100 for creating numerical sequences that can educate, entertain and improve the cognitive abilities of many players. Here, among other components, numerical board game 100 comprises game board 106 and a plurality of playing pieces or tiles 108.

Game board 106 is a hexagonal-shaped panel on which playing pieces 108 may be placed to form numerical sequences. Specifically, game board 106 includes 91 equal-sided hexagons or grids 107 nestled together in a honeycomb arrangement. A playing piece 108 may be placed on a grid 107.

Although not shown, game board 106 may be triangular, square, pentagonal or other shapes consistent with the spirit and scope of the present disclosure. The number of grids may also vary in other embodiments. Game board 106 is preferably composed of cardboard. However, other comparable materials such s plastic, wood, consistent with the spirit and scope of the present disclosure.

As noted, game board 106 is hexagonal-shaped. This hexagonal shape allows the placement of placing pieces 108 adjacent to each other along one or more directions on the board. Each side 110 of hexagonal shaped game board 106 has the same length. In one embodiment, each game board 106 is approximately 7 inches in length on all sides.

Game board 106 is also configured to permit easy folding and storage of game board after a game is played. The size of each game board 106 may also vary so that it can be used on different sized playing surfaces and by two or more users.

In FIG. 1, numerical board game 100 includes 82 playing pieces 108 that are also hexagonal shaped. The hexagonal shape of each playing piece 108 corresponds to that of each grid 107 of game board 106. Each playing piece 108 has a smaller dimension relative to grid 107 so that each playing piece 108 can fit within grid 107 as the game is played. Playing pieces 108 may be 1/32 inches smaller than the size of the grid 107.

In FIG. 1, numerical board game 100 further includes playing pieces holder 112 on which playing pieces 108 are placed as the numerical sequence game is played. Each player 102, 104 is assigned a single playing pieces holder 112.

In one embodiment, as shown, each playing piece 108 includes a sequencing numerical integer on one face of the playing piece. Specifically, in FIG. 1, sequencing numerical integers 3, 5, 1, 7 can be seen on playing pieces holder 112 of player 104. Sequencing numerical integers 5, 1 and 3 can be seen on playing pieces holder 112 of player 102.

As used herein, a sequencing numerical integer might be a single digit or number that is part of a sequence or facilitates sequencing or arranging of playing pieces 108 into a numerical sequence of adjacent playing pieces where each numerical sequence includes a determined difference between adjacent playing pieces. The numerical sequence between each adjacent playing piece 108 is determined by a user based on the playing pieces that the user has in his or her possession. More specifically, the sequence is a sequence of tiles played in a horizontal across, diagonal up and diagonal down directions where the tiles are placed adjacent to each other and there is a difference in number between adjacent tiles.

The playing pieces 108 might be made of durable polymeric material, such as plastic, wood, glass, or other materials consistent with the spirit and scope of the present disclosure.

Briefly, in operation, each player 102, 104 picks six of the 82 playing pieces 108. Although not shown, the playing pieces may be stacked or stored in a drawstring bag so that the users may pick playing pieces without looking at the pieces. After playing pieces 108 are picked, each player 102, 104 then takes a turn creating numerical sequences on game board 106.

Numerical sequences can be in a horizontal direction, diagonal up direction or diagonal down direction as further described with reference to the drawings below. Each playing piece 108 is assigned a point value and the total point value accumulated by each player 102, 104 for his or her numerical sequences is then tallied. The player with the highest point value wins the game.

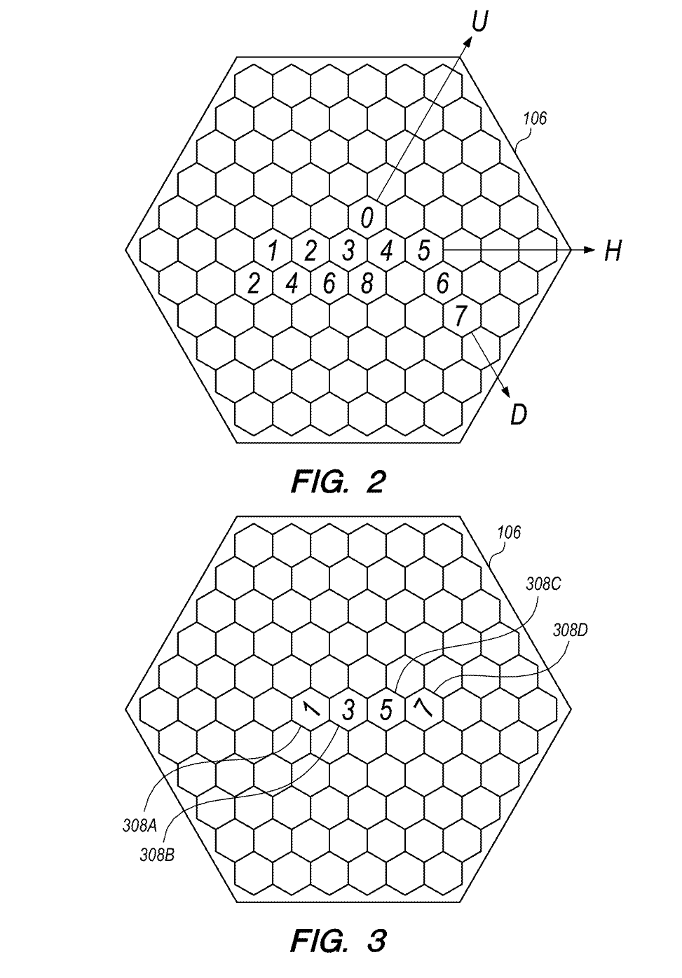

FIG. 2 illustrates game board 106 showing the directions in which playing pieces may be placed.

In FIG. 2, playing pieces 108 may be placed in a horizontal direction represented by arrow H, they may be placed in a diagonal down direction represented by arrow D, and they may be place in a diagonal up direction represented by arrow U. Here, playing pieces 108 with numerical digits 1, 2, 3, 4, 5 are shown in the horizontal direction, while playing pieces 5, 6, 7 are shown in the diagonal down direction, D. Playing pieces 6, 3, 3, 3, 3 are shown in the U direction.

FIG. 3 illustrates game board 106 of FIG. 1 showing slanted and upright positions during the course of the game.

In FIG. 3, playing piece 308A, “1,” and playing piece 308D, “7,” are shown slanted to the left. This slanted position indicates that playing piece 308A and playing piece 308D are placed during the current turn of a player. In contrast, playing piece 308B “3,” and playing piece 308C, “5,” are shown upright on game board 106. This upright position indicates that the playing pieces were placed by the previous player during their prior turn.

By placing current pieces in a slanted position, a player's score during the current turn can be easily tabulated or tallied since the tiles that were placed during the player's turn can be easily differentiated from the prior tiles, which are upright.

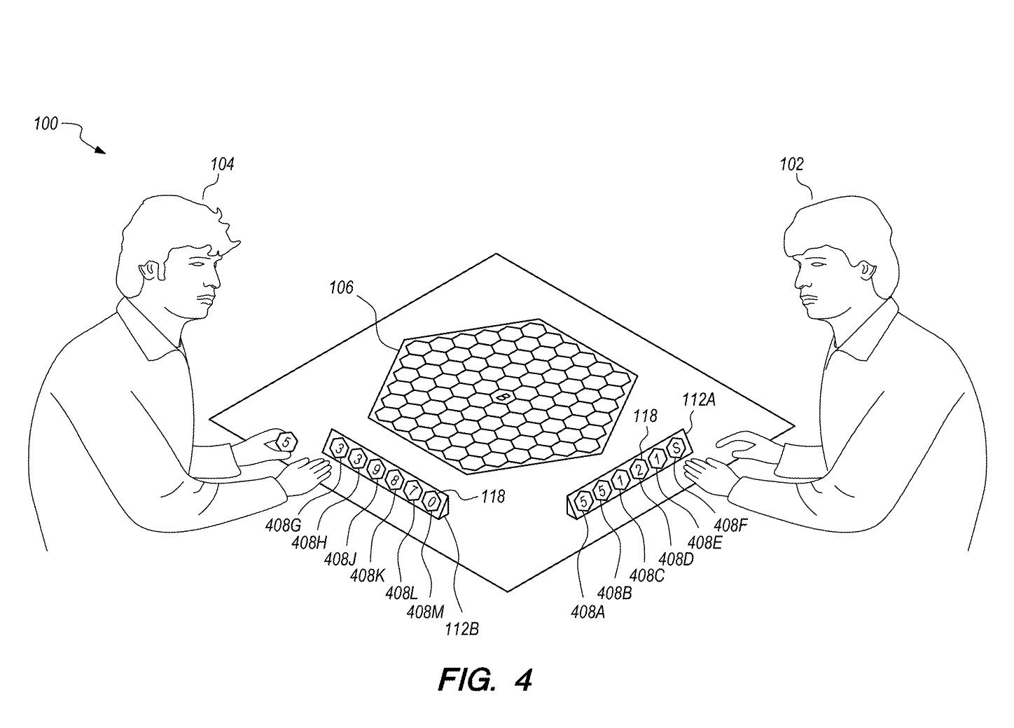

FIG. 4 illustrates play of numerical board game 100 of FIG. 1 according to the exemplary embodiment of the present disclosure.

In FIG. 4, specifically, two players, 102 and 104, are playing numerical board game 100. Although not shown, additional players up to six players may play the game against each other. Play begins when each player 102, 104, picks six playing pieces from a drawstring bag (not shown) that contains all of the 82 playing pieces. Here, player 102 has picked playing piece 408A, “5,” playing piece 408B, “5,” playing piece 408C, “1,” playing piece 408D, “2,” playing piece 408E, “1,” and playing piece 408F, “S.”

As shown, player 102 has placed his selected playing pieces on playing piece holder 112A. Note that playing piece 408F has a sequencing integer that is the letter S. This letter or tile represents a special playing piece, or Super Tile, that can represent any of the sequencing numerical integers.

In FIG. 4, the second player, namely player 104, also picks six playing pieces, namely playing piece 408G, “3,” playing piece 408H, “3,” playing piece 408J, “9,” playing piece 408K, “8,” playing piece 408L, “7,” and playing piece 408M, “0.” The selected playing pieces are then placed on playing piece holder 112B.

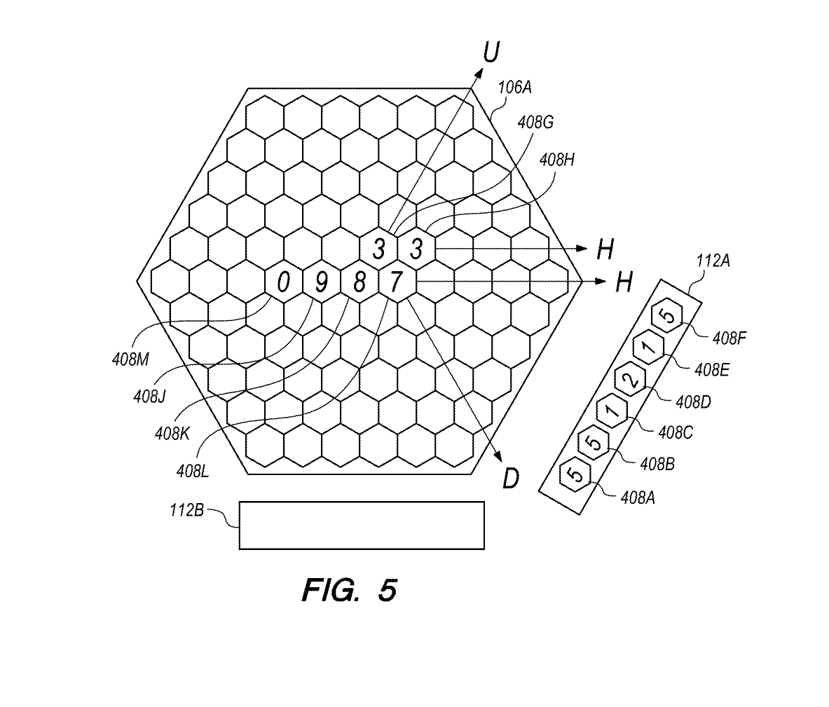

After determining order of play, player 102 is designated to begin the game. Player 102 looks for numerical sequences that can be formed by his playing pieces 408A, 408B, 408C, 408D, 408E, and 408F, as further illustrated in FIGS. 5 to 8 below. As used herein, a numerical sequence is a sequence of tiles played in a horizontal across, diagonal up and diagonal down directions where the tiles are placed adjacent to each other and there is a difference in number between adjacent tiles.

FIG. 5 illustrates game board 106 of FIG. 4 showing a numerical sequence formed by player 104 during a first round of play.

In FIG. 5, player 104 has used playing piece 408M, playing piece 408J, 408K, 408L (picked in FIG. 4) to form a numerical sequence 0, 9, 8, 7 in the horizontal across direction as shown by arrow H. Here, numerical sequence 0, 9, 8, 7 has a numerical difference of one between each adjacent playing piece. For example, the numerical difference between playing piece 408K, “8” and 408L, “7” is one.

Similarly, the numerical difference between playing piece 408J, “9,” and 408K, “8,” is one as well. The numerical difference between playing piece 408M, “0,” and 408J, “9,” is one as well. However, note that playing piece 408M, “0,” here represents a sequencing integer of “10.” The “ten position” 0 is displayed, but the “unit position” 1 is not displayed. Here, the “1” of the “unit position” is an imaginary number associated with the “0” so that playing piece 408M is “10.” An advantage of the present disclosure is that players can add another digit to a single sequencing integer to create double digit sequencing numerical integer, although this added digit is imaginary and not indicated on the playing piece.

In FIG. 5, as shown, playing pieces 408H, “3,” and playing piece 408G, “3,” both also form a numerical sequence in the horizontal direction. Playing piece for 408H, “3,” and playing piece 408L also form a numerical sequence 3, 7, in the down direction, as shown by the arrow D. Once player 104 has placed all of his or her tiles or playing pieces as indicated above, player 104 may now tally up the total point values for the tiles here.

Initially, each playing piece is assigned a point value except where the playing piece is on a base “B” grid (not shown) in which case another 6 points is assigned to the tile on the base grid. In one embodiment, the point value assigned to each playing piece is 1 point, although other values may be assigned as well. Thus, in FIG. 5, the numerical sequence 0, 9, 8, 7 has a point value of 4. In addition, although not shown, playing piece 408K “8” is on the base B grid so that playing piece is assigned 6 points (every game begins when a player places a playing piece on the base B grid—here playing piece 408K was placed on the base grid to initiate the game).

Thus the total point value for sequence 0, 9, 8, 7 is 4+6 points=10 points. Total point value for the sequence 3, 3 is also calculated, thus for that sequence 3, 3, the total point value is 2 (value of playing piece 408H is 1 and the value of playing piece 408G is 1). The total point value in the diagonal down direction is then tallied. Here, for the sequence 3, 7, the total point value is 2 (1 for playing piece 408H plus 1 for playing piece 408L).

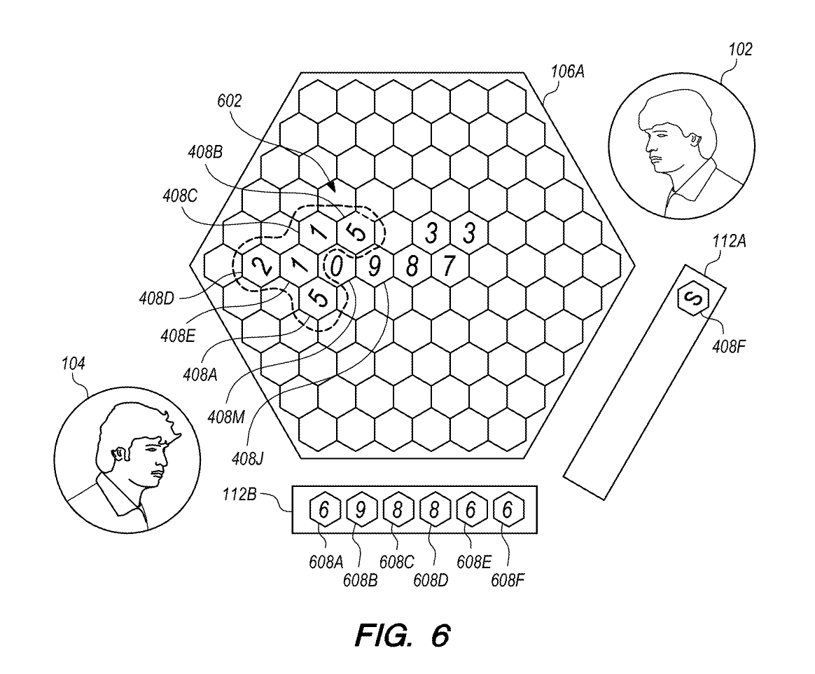

Finally, in the diagonal up direction U, the numerical sequence 8, 3, has a total point value of 2 (1 for the playing piece 408K and one for the playing piece 408H). Therefore, the total point value for player 104 for his turn on playing pieces is 10+2+2+2=16 points. Once player 104 has completed play, player 102 can then take a turn as shown in FIG. 6.

FIG. 6 illustrates game board 106 showing playing pieces that are placed by player 102 during a second round of play following the first round of play by player 104 in FIG. 5.

In FIG. 6, as can be seen, player 102 has played various playing pieces represent generally as hashed lines 602. Specifically, player 102 has played playing piece 408A, playing piece 408E, playing piece 408D, playing piece 408C, and playing piece 408B. These playing pieces are used with prior playing pieces placed during previous turns to create numerical sequences.

Player 102 can also use his playing pieces that were placed during a previous turn to also initiate a numerical sequence, unlike traditional board games. The present disclosure also unlike traditional board game systems, does not attempt to use playing pieces to block other players from executing a numerical sequence. Rather, the present disclosure simply facilitates players using math by thinking of differences between numbers or thinking of numerical sequences where the difference between adjacent playing pieces are the same.

Specifically, in FIG. 6A, player 102 has played playing piece 408E, “1,” adjacent to playing piece 408M, “0,” that was played by player 104 during the previous turn. Player 102 has also played playing piece 408D, “2,” adjacent to playing piece 408E, “1.” In this manner, a sequence 2, 1, 0, 9, 8, 7 is formed in the horizontal across direction. It is noted that because player 102 is playing during this turn, the playing pieces are slanted to distinguish player 102's playing pieces from player 104's playing pieces that were played during the previous turn.

As can be seen, the sequence 7, 8, 9, 10, 11, 12 has a difference of one between each adjacent tile or playing piece. For example, the difference between playing piece 108E, “11,” and playing piece, 408D, “12,” is 1. Here it is also noted that although playing piece 408E shows the numerical sequencing integer, ‘1,’ it is equivalent to an 11, while playing piece 408D shows a numeric designation of ‘2,’ it is equivalent to a “12,” as used in this particular sequence. The total for this sequence, 7, 8, 9, 10, 11, 12 is 6 points, each playing piece counting for one point.

In FIG. 6, player 102 has also played playing piece 408C, “1,” and playing piece 408B, “5,” in the horizontal direction. The difference between playing piece 408C, “1” and playing piece 408B, “5,” is four. Therefore, this numerical sequence is a valid one. Note that even where only two playing pieces are played, the sequence is valid so long as those two tiles form a valid numerical sequence with previously played tiles. The point total for sequence 1, 5 is therefore 2 points.

Playing piece 408E and playing piece 408A also form a numerical sequence in the diagonal down direction, having a difference of four with a resulting total of 2 points. Playing piece 408C and playing piece 408M form a sequence 0, 1, having a difference of one and a total of 2 points.

Playing piece 408B and playing piece 408J that was previously played by player 104 form a sequence 5, 9, having a difference of four and a total of 2 points. Playing piece 408E and playing piece 408C also form a sequence 1, 1 in the diagonal up direction with a total of 2 points. Playing piece 408, playing piece 408M, and playing piece 408B form a numerical sequence 5, 10, 15, in the diagonal up direction.

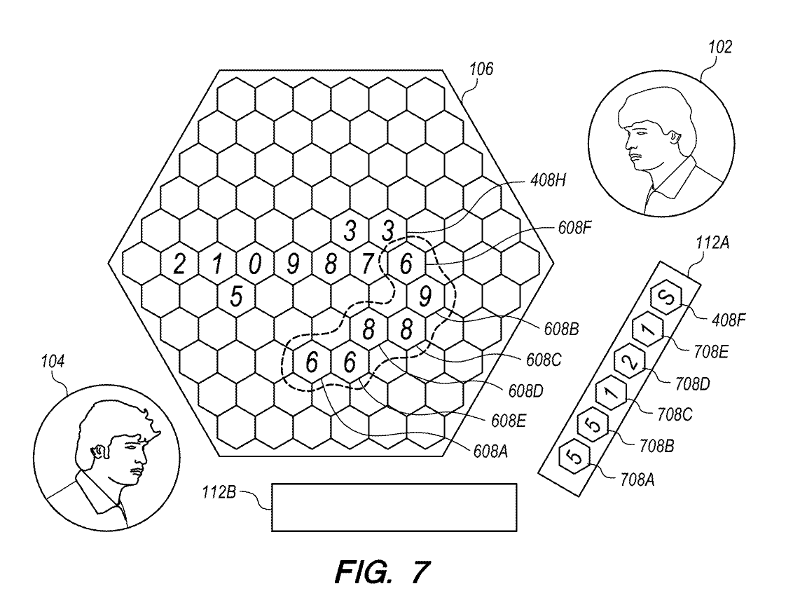

And since there are three playing pieces in this sequence, the total is 3 points. Therefore, the point total accumulated during this turn by player 102 is 6+2+2+2+2+3=17 points. It is noted here that special playing piece 408F remains on player 102's playing piece holder 112A. After player 102 has completed his turn, player 104 may pick a new set of playing pieces from the drawstring bag. Here, the playing pieces picked by player 104 are shown on playing piece holder 112B. The selected playing pieces are 608A, 608B, 608C, 608D, 608E, and 608F. These selected playing pieces are then played by player 104 during the next turn as illustrated in FIG. 7 below.

FIG. 7 illustrates game board 106 according to an exemplary embodiment of the present disclosure.

In FIG. 7, player 104 has played his selected playing pieces after player 102's turn as described in FIG. 6. As shown, the playing pieces placed by player 104 are shown by hashed lines. In particular, the placed playing pieces are playing piece 608F, “6,” playing piece 608B, “9,” playing piece 608C, “8,” playing piece 608D, “8,” playing piece 608E, “6,” and playing piece 608A, “6.”

Here, a sequence 6, 6 is formed by playing piece 608A and 608E in the horizontal direction to provide a total points value of two points. Playing pieces 608C and 608D form a numerical sequence 8, 8 that provide a total point value of 2 points. Playing piece 608F is placed to form a numerical sequence 6, 7, 8, 9, 10, 11, 12, for a total point value of 7 points. In the diagonal up direction, playing pieces 608E and 608D form a numerical sequence 6, 8 with a difference of two for a total of 2 points.

Playing pieces 608C and playing piece 608B form a numerical sequence 8, 9, with a difference of one, for a total of 2 points. Finally, playing piece 408H, playing piece 608F, and playing piece 608B form a numerical sequence 3, 6, 9, having a difference of three between each adjacent playing pieces for a total of 3 points.

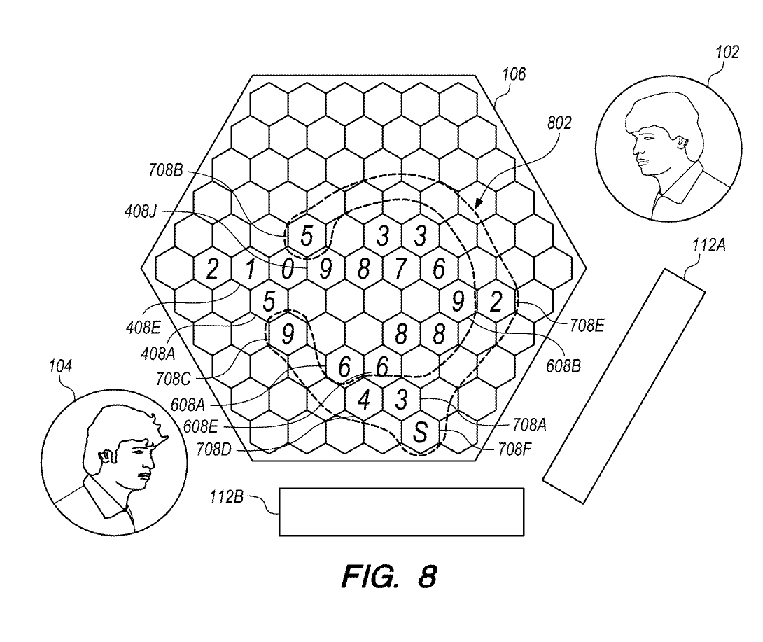

Therefore, the total points for player 104 during this turn is 2+2+7+2+2+3=18 points. As can be seen in FIG. 7, player 102 has selected a new set of playing pieces and has placed them on playing piece holder 112A in preparation for his turn as further illustrated in FIG. 8.

FIG. 8 illustrates game board 106 according to an exemplary embodiment of the present disclosure.

In FIG. 8, player 104 has placed the playing pieces (indicated within hashed lines 802) on game board 106. Specifically, player 102 has placed playing piece 708B, “5,” playing piece 708E, “2,” playing piece 708A, “3,” playing piece 708F, “S,” playing piece 708D, “4,” and playing piece 708C, “9.”

Here, playing piece 708A and playing piece 708D form a numerical sequence 3, 4 in the horizontal direction, having a difference of one for a total of two points. Playing piece 708E and playing piece 608B form a numerical sequence 2, 9, having a difference of seven for a total of two points.

1571 Playing piece 408E, playing piece 408A, and playing piece 706C form a numerical sequence 1, 5, 9, having a difference of four, the playing pieces forming a sequence with a total of three points in the diagonal down direction. Playing piece 708D and playing piece 608E form a numerical sequence 4, 6, having a difference of two in the diagonal down direction for a total of two points.

Playing piece 708F, playing piece 708A, and playing piece 608E form a numerical sequence 0 (“S” is 0), 3, 6, with a difference of three for a total of three points in the diagonal down direction. Note here that playing piece 708F has the alphabet S which is special and which can represent any number. Here, the alphabet S represents a ‘0.’

Playing piece 708B and playing piece 408J form a numerical sequence 5, 9 with a difference of four in the diagonal down direction for a total of 2 points. Therefore, the total points accumulated by player 102 for this play is 2+2+3+2+3+2=14 points. Play continues in this manner until all of the playing pieces in the drawstring bag are exhausted, after which all of the players tally up their total points.

The player with the highest total point value is the winner. In another embodiment, any playing pieces that are left un-played by a player may be deducted from the total point value. In this manner, the present disclosure facilitates and encourages numerical and mathematical thinking helps both young and adult players increase their mathematical skills, stimulates the brain, and provides entertainment as necessary.

While the above is a complete description of exemplary specific embodiments of the disclosure, additional embodiments are also possible. Thus, the above description should not be taken as limiting the scope of the disclosure, which is defined by the appended claims along with their full scope of equivalents.

I claim:

1. A board game comprising:
a gridded board having a plurality of grids, each one of the plurality of grids having a hexagonal shape;
a plurality of playing pieces or tiles that are place-able on the plurality of grids, each one of the plurality of playing pieces having a hexagonal shape that corresponds to and that is no larger than the hexagonal shape of the plurality of grids on the gridded board,
wherein each one of the plurality of playing pieces includes a numerical indicia on at least one face of the playing piece; and wherein each one of said plurality of playing pieces is place-able adjacent to one another on the gridded board to form a numerical sequence of numbers based on the numerical indicia on the at least one face of each playing piece, wherein the numerical sequence of numbers is formed in at least one of a horizontal direction, a diagonal up direction and a diagonal down direction,
wherein for each numerical sequence, a numerical difference that is determined by the user, exists between a first playing piece in the numerical sequence and a second playing piece that is adjacent to the first playing piece, wherein the same numerical difference also exists between the second playing piece and a third playing piece that is placed adjacent to the second playing piece.

2. The board game of claim 1 wherein the numerical indicia is a single digit that is displayed on the at least one face of the playing piece.

3. The board game of claim 1 wherein the numerical indicia is a double digit, wherein a first digit of said double digit is displayed on a face of the playing piece and a second digit is not displayed.

4. The board game of claim 3 wherein the second digit that is not displayed is a digit assigned to the playing piece by the user.

5. The board game of claim 1 wherein each playing piece in a formed numerical sequence is assigned a point value.

6. The board game of claim 5 wherein a total point value for a numerical sequence is the total point value obtained by adding the point value of each playing piece in the numerical sequence.

7. The board game of claim 1 wherein a winner of the board game is the player with the high point value determined by adding the total point values for all numerical sequences formed by the player.

8. A method comprising:
providing a gridded board having a plurality of grids, each one of the plurality of grids having a hexagonal shape;
placing a plurality of playing pieces or tiles on the plurality of grids, each one of the plurality of playing pieces having a hexagonal shape that corresponds to and that is no larger than the hexagonal shape of the plurality of grids on the gridded board,
wherein each one of the plurality of playing pieces includes a numerical indicia on at least one face of the playing piece; and wherein each one of said plurality of playing pieces is place-able adjacent to one another on the gridded board to form a numerical sequence of numbers based on the numerical indicia on the at least one face of each playing piece, wherein the numerical sequence of numbers is formed in at least one of a horizontal direction, a diagonal up direction and a diagonal down direction,
wherein for each numerical sequence, a numerical difference that is determined by the user, exists between a first playing piece in the numerical sequence and a second playing piece that is adjacent to the first playing piece, wherein the same numerical difference also exists between the second playing piece and a third playing piece that is placed adjacent to the second playing piece.

9. The method of claim 8 wherein the numerical indicia is a single digit that is displayed on the at least one face of the playing piece.

10. The method of claim 8 wherein the numerical indicia is a double digit, wherein a first digit of said double digit is a “unit position” that is displayed but a second digit of the double digit is a “ten position” that is not displayed on a face of the playing piece.

11. The method of claim 10 wherein the second digit of the “ten position” that is not displayed is a digit assigned to the playing piece by the user.

12. The method of claim 8 wherein each playing piece in a formed numerical sequence is assigned a point value.

13. The method of claim 8 wherein a total point value for a numerical sequence is the total point value obtained by adding the point value of each playing piece in the numerical sequence.

14. The method of claim 8 wherein a winner of the board game is the player with the high point value determined by adding the total point values for all numerical sequences formed by the player.

15. The method of claim 8 wherein the numerical indicia is a double digit, wherein a first digit of said double digit is displayed on a face of the playing piece and a second digit is not displayed.
